(19) United States
(12) Patent Application Publication
(10) Pub. No.: US 2019/0280264 A1
(43) Pub. Date: Sep. 12, 2019

(54) BATTERY MODULE

(71) Applicant: TOYOTA JIDOSHA KABUSHIKI KAISHA, Toyota-shi (JP)

(72) Inventor: Yusuke KURUMA, Toyota-shi (JP)

(73) Assignee: TOYOTA JIDOSHA KABUSHIKI KAISHA, Toyota-shi (JP)

(21) Appl. No.: 16/274,439

(22) Filed: Feb. 13, 2019

(30) Foreign Application Priority Data
Mar. 7, 2018 (JP) 2018-040571

(51) Int. Cl. H01M 2/10; H01M 2/20; H01M 2/02; H01M 2/30

(52) U.S. Cl. CPC H01M 2/1077; H01M 2/206; H01M 2220/20; H01M 2/30; H01M 2/0237

(57) ABSTRACT

A short circuit of a terminal provided on an end plate is suppressed. A terminal for electrically connecting adjacent battery modules is provided on an end plate. The end plate has a plate main body and a projection. The projection is formed of an upper surface of the end plate which projects from the plate main body to be away from cells in a width direction which is the stack direction of the cells. In plan view of the battery module, the terminal is disposed in a range in which the projection is provided in the front-rear direction orthogonal to the width direction.

This nonprovisional application is based on Japanese Patent Application No. 2018-040571 filed on Mar. 7, 2018 with the Japan Patent Office, the entire contents of which are hereby incorporated by reference.

### BACKGROUND

### Field

The present disclosure relates to battery modules.

### Description of the Background Art

A conventionally proposed power storage module includes a power storage battery group including a stack of a plurality of storage batteries and is provided with end plates located at the opposite ends in a stack direction. The end plate is provided with a terminal block electrically connecting an electrode terminal of the storage battery disposed at the end in the stack direction to an output line (e.g., see Japanese Patent Laying-Open No. 2016-18766).

### SUMMARY

When the end plate is provided with a terminal for electrical connection, seepage of water into a housing case, which houses the battery module, may cause water to flow by the gravity to be directed along the end plate, leading to a short circuit between the terminal for electrical connection and a conductive member provided on the end plate.

The present disclosure provides a battery module capable of suppressing a short circuit of a terminal provided on an end plate.

According to the present disclosure, a battery module mounted in a vehicle is provided. The battery module includes a stack including a plurality of cells stacked, an end plate disposed on at least one side of the stack in a stack direction of the cells, and a terminal provided on an upper surface of the end plate for electrically connecting adjacent battery modules. The end plate has a main body having a plate shape, and a projection formed of the upper surface projecting from the main body to be away from the stack in the stack direction. In plan view of the battery module, the terminal is disposed in a range in which the projection is provided in an orthogonal direction orthogonal to the stack direction.

Such a configuration forms, if water accumulates in the vicinity of the terminal, a path for water flowing down from the upper surface of the end plate along the projection. The water flowing down from the upper surface is suppressed from flowing along the surface of the end plate, thereby suppressing an electrical connection between a conductor provided on the surface of the end plate and the terminal through the flowing water. This can suppress a short-circuit of the terminal.

In the battery module, at least part of the terminal is provided in the projection. The disposition of the terminal is defined as described above, more reliably allowing water flowing through the vicinity of the terminal to flow down along the projection.

In the battery module, the main body has an inner surface facing the stack and an outer surface opposite to the inner surface. The projection projects with respect to the outer surface. The battery module further comprises a conductor attached to the outer surface. The projection projects from the outer surface by an amount greater than that of the conductor. Defining a height by which the projection projects as described above can avoid water, which flows down from the upper surface of the end plate, flowing through the conductor. This can more reliably suppress an electrical connection between the terminal and the conductor through the flowing water.

In the battery module, the end plate has a recess-shaped portion formed of a recessed part of the upper surface. The terminal is provided in the recess-shaped portion. The projection is formed of the recess-shaped portion projecting in the stack direction. Although the water that has arrived at the upper surface of the end plate is guided by a recessed shape to easily accumulate in the vicinity of the terminal, the projection is formed of the recess-shaped portion projecting, thereby allowing the water that has accumulated in the vicinity of the terminal to flow down along the projection without flowing along the surface of the end plate. This can more reliably suppress an electrical connection between the terminal and the conductor through the flowing water.

In the battery module, the projection has a tip end surface running in an up-down direction. This allows water flowing down from the upper surface of the end plate along the projection to easily flow along the tip end surface to drip from the lower edge of the tip end surface. Consequently, water dripping down from the projection to the conductor can be avoided more reliably.

In the battery module, the projection has a lower surface facing downward. At the lower edge on the tip end surface which defines a boundary between the lower surface and the tip end surface, the tip end surface and the lower surface form an angle of 900 or less. This allows water to drip from the lower edge of the tip end surface, more reliably avoiding water flowing from the projection to the conductor.

In the battery module, the tip end surface has a groove running in a direction crossing the up-down direction. The formation of the groove leads to the formation of an irregular shape having a drainage function, more effectively suppressing water flowing down along the tip end surface of the projection from flowing through the surface of the end plate.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic side view of a vehicle.

FIG. 2 is a perspective view schematically showing the appearance of a power storage device.

FIG. 3 is a plan view schematically showing the power storage device with a lid removed.

FIG. 4 is an exploded perspective view of a battery module.

FIG. 5 is a sectional view showing a configuration of a cell.

FIG. 6 is a schematic view of a stack of cells and an end plate which are viewed laterally.

FIG. 7 is a schematic view of the end plate and the terminal in plan view.

FIG. 8 is a side view showing a configuration of an end plate according to Embodiment 2.

### DESCRIPTION OF THE PREFERRED EMBODIMENTS

A battery module in an embodiment will be described below with reference to the drawings. In the embodiments below, the identical or substantially identical components are denoted by the same reference characters, and are not described repeatedly.

### Embodiment 1

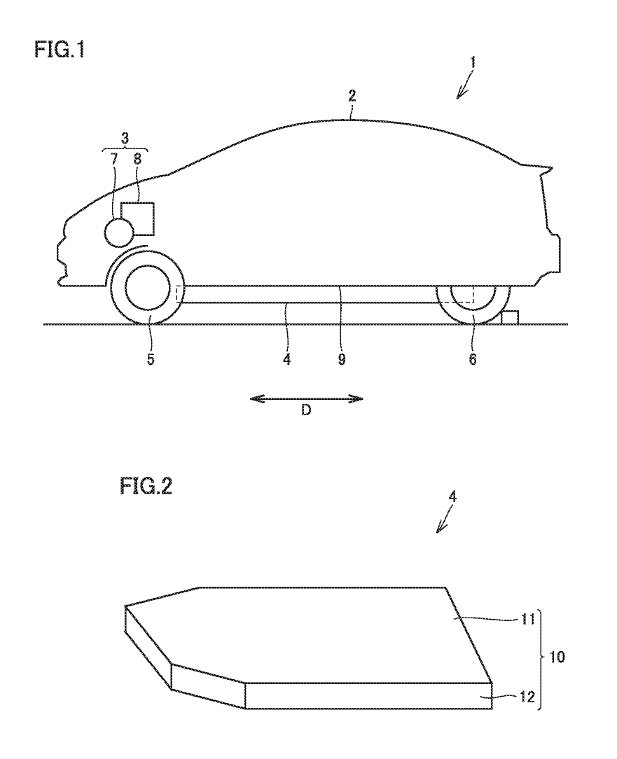

FIG. 1 is a schematic side view of a vehicle 1. Vehicle 1 includes a vehicle body 2, a drive device 3, a power storage device 4, front wheels 5, and rear wheels 6. Front wheels 5 are provided on the front side with respect to the center in a front-rear direction D of vehicle 1. Rear wheels 6 are provided on the rear side with respect to the center in front-rear direction D.

Vehicle body 2 has an onboard space, a front accommodation space, and a rear accommodation space. The onboard space is a space in which occupants such as a driver board. The rear accommodation space is formed behind the onboard space. The rear accommodation space can accommodate baggage or the like. The front accommodation space is formed in front of the onboard space. The front accommodation space houses drive device 3 or the like.

Vehicle body 2 includes a skeleton frame, and the skeleton frame includes a floor panel 9. Floor panel 9 forms the bottom face of vehicle body 2.

Drive device 3 includes a rotating electric machine 7 and a. PCU (Power Control Unit) 8. PCU 8 is electrically connected to rotating electric machine 7 and power storage device 4. PCU 8 includes an inverter and a converter. Rotating electric machine 7 is mechanically connected to front wheels 5.

Power storage device 4 is provided on the lower surface of floor panel 9. Power storage device 4 supplies DC power to PCU 8. PCU 8 boosts the supplied DC power and then converts the DC power into AC power. Rotating electric machine 7 uses the AC power supplied from PCU 8 to generate a driving force for rotating front wheels 5.

Vehicle 1 may be an electric vehicle, a hybrid vehicle, or a plug-in hybrid vehicle.

FIG. 2 is a perspective view schematically showing the appearance of power storage device 4. Power storage device 4 includes a battery case 10. Battery case 10 includes a case body 12 and a lid 11. Case body 12 is formed to be hollow and includes a bottom plate and a peripheral wall portion extending along the perimeter of the bottom plate. An opening, which is open upward, is formed in case body 12. Case body 12 is formed of, for example, a metal material such as aluminum alloy. Case body 12 is fixed to floor panel 9.

Lid 11 is provided to case body 12 to close the opening of case body 12. Lid 11 is made of, for example, resin for reduced weight of battery case 10.

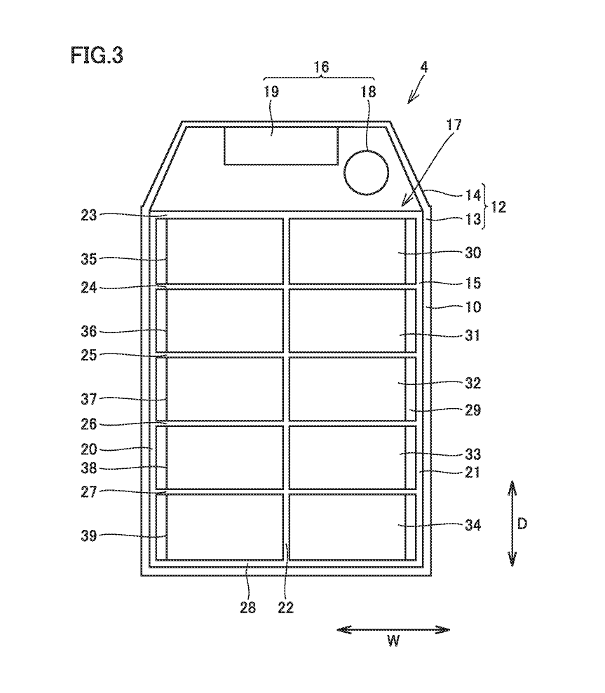

FIG. 3 is a plan view schematically showing power storage device 4 with lid 11 removed. Case body 12 includes a main body 13 and a projection 14. Main body 13 is shaped into a substantially rectangular solid. Projection 14 is formed to project forward from the front end of main body 13. Projection 14 is formed to have a smaller length in a width direction W of vehicle body 2, from a portion at which projection 14 is connected with main body 13 toward the front of the vehicle.

Power storage device 4 includes a reinforcing member 15, in-vehicle devices 16, and a power storage unit 17. In-vehicle devices 16 are provided in projection 14. In-vehicle devices 16 include a cooling device 18 and a junction box 19. Cooling device 18 is a device that cools power storage unit 17.

Reinforcing member 15 is disposed in main body 13. Reinforcing member 15 includes a bottom plate 29 and a plurality of frames arranged in a lattice pattern. Bottom plate 29 of reinforcing member 15 is disposed on the upper surface of the bottom plate of case body 12.

Reinforcing member 15 includes side frames 20 and 21, a center frame 22, and cross frames 23 to 28.

Side frames 20 and 21 and center frame 22 are formed to run in front-rear direction D. Side frames 20 and 21 are spaced in width direction W, and center frame 22 is disposed between side frames 20 and 21.

Cross frames 23 to 28 are formed to run in width direction W. Each of cross frames 23 to 28 is formed to connect side frame 20 to side frame 21. Cross frames 23 to 28 are spaced in front-rear direction D.

As described above, a plurality of frames are arranged in a lattice pattern, and the plurality of frames and bottom plate 29 define a space in which each of battery modules 30 to 39 is accommodated. Battery module 30 is housed in accommodation space defined by cross frames 23 and 24, side frame 21, and center frame 22. Battery module 35 is housed in accommodation space defined by cross frames 23 and 24, side frame 20, and center frame 22.

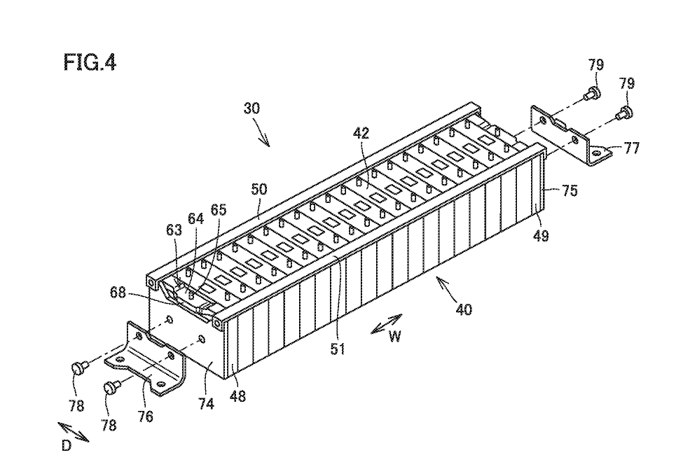

FIG. 4 is an exploded perspective view of battery module 30. As shown in FIG. 4, battery module 30 includes a stack 40. Stack 40 (battery stack) is composed of a plurality of cells 42 stacked in width direction W.

FIG. 5 is a sectional view showing a configuration of cell 42. As shown in FIG. 5, cell 42 includes a housing case 80, a positive electrode external terminal 83, a negative electrode external terminal 84, an electrode assembly 85, an electrolyte 88, a positive electrode collector terminal 89, and a negative electrode collector terminal 90.

Housing case 80 is made of aluminum or aluminum alloy. Housing case 80 includes a case body 81 and a lid 82. Case body 81 has an opening which is open upward. Lid 82 is welded to case body 81 to close the opening of case body 81.

Positive electrode external terminal 83 and negative electrode external terminal 84 are provided on the upper surface of lid 82. Positive electrode external terminal 83 and negative electrode external terminal 84 are connected with a bus bar, which will be described below. Positive electrode external terminal 83 and negative electrode external terminal 84 are disposed outside housing case 80. Electrode assembly 85, electrolyte 88, positive electrode collector terminal 89, and negative electrode collector terminal 90 are housed in housing case 80.

Electrode assembly 85 is formed of a plurality of negative electrode sheets, a plurality of positive electrode sheets, and a plurality of separators, which are stacked. Electrode assembly 85 may be of stack type or winding type.

The negative electrode sheet includes a metal foil made of copper or the like and negative electrode composite material layers formed on the front and rear surfaces of the metal foil. The negative electrode composite material layer contains, for example, a negative electrode active material and a binder. The negative electrode active material may be, for example, a carbonaceous material. The metal foil of the negative electrode sheet has an unapplied portion in which no negative electrode composite material layer is formed.

The positive electrode sheet includes a metal foil of aluminum or the like and positive electrode composite material layers formed on the front and rear surfaces of the metal foil. The positive electrode composite material layer contains, for example, a positive electrode active material and a binder. The metal foil of the positive electrode sheet has an unapplied portion in which no positive electrode composite material layer is formed. The separator is formed of microporous resin sheet or nonwoven fabric.

Electrode assembly 85 includes a positive electrode portion 86 and a negative electrode portion 87. Positive electrode portion 86 is formed of the unapplied portion of the positive electrode sheet. Negative electrode portion 87 is formed of the unapplied portion of the negative electrode sheet.

Positive electrode collector terminal 89 is provided to connect positive electrode portion 86 to positive electrode external terminal 83. Negative electrode collector terminal 90 is provided to connect negative electrode portion 87 to negative electrode external terminal 84.

Electrolyte 88 contains at least one of PC (Propylene Carbonate) and EC (Ethylene Carbonate). Electrolyte 88 contains an additive. At least one of VA (Vinyl Acetate), ADV (Divinyl Adipate), and ACM (AllylMethyl Carbonate) is contained as the additive.

Referring back to FIG. 4, battery module 30 further includes end plates 48 and 49 and restraining bands 50 and 51.

End plates 48 and 49 extend orthogonal to width direction W which is the stack direction of cells 42. End plate 48 is disposed at the end on one side of stack 40 in width direction W. End plate 49 is disposed at the end on the other side of stack 40 in width direction W. End plate 48 and end plate 49 are positioned to sandwich stack 40. At least the outer surfaces of end plates 48 and 49 are formed of an insulating material such as resin. End plates 48 and 49 may be entirely made of insulating material or may be formed of a metal plate-shaped member and an insulating member covering the surface of the plate-shaped member.

Restraining bands 50 and 51 extend in width direction W. Restraining bands 50 and 51 connect end plate 48 to end plate 49. More specifically, a plate-shaped reinforcing bracket 74 is attached to end plate 48, and a plate-shaped reinforcing bracket 75 is attached to end plate 49. Restraining bands 50 and 51 each have one end fixed to reinforcing bracket 74 and the other end fixed to reinforcing bracket 75. Restraining bands 50 and 51 apply a restraining load in width direction W to cells 42, thereby restraining cells 42 in width direction W.

An attachment bracket 76 is attached to reinforcing bracket 74. Attachment bracket 76 is formed as a generally L-shaped angle bracket, which has a first surface and a second surface approximately orthogonal to the first surface. Fixtures 78 pass through through-holes formed in the first surface of attachment bracket 76 to be attached to attachment holes formed in reinforcing bracket 74, thereby fixing attachment bracket 76 to reinforcing bracket 74. The second surface of attachment bracket 76 is fixed to reinforcing member 15, more specifically, to bottom plate 29 or a frame (center frame 22) with a fixture (not shown).

An attachment bracket 77 is attached to reinforcing bracket 75. Attachment bracket 77 is formed as a generally L-shaped angle bracket, which has a first surface and a second surface approximately orthogonal to the first surface. Fixtures 79 pass through through-holes formed in the first surface of attachment bracket 77 to be attached to attachment holes formed in reinforcing bracket 75, thereby fixing attachment bracket 77 to reinforcing bracket 75. The second surface of attachment bracket 77 is fixed to reinforcing member 15, more specifically, to bottom plate 29 or a frame (side frame 21) with a fixture (not shown).

Reinforcing brackets 74 and 75 are conductors made of a conductive material such as metal. Attachment brackets 76 and 77 are formed of a conductive material such as metal and are grounded. Fixtures 78 and 79 respectively fixing attachment brackets 76 and 77 to reinforcing brackets 74 and 75 and the respective fixtures fixing attachment brackets 76 and 77 to reinforcing member 15 are, for example, bolts.

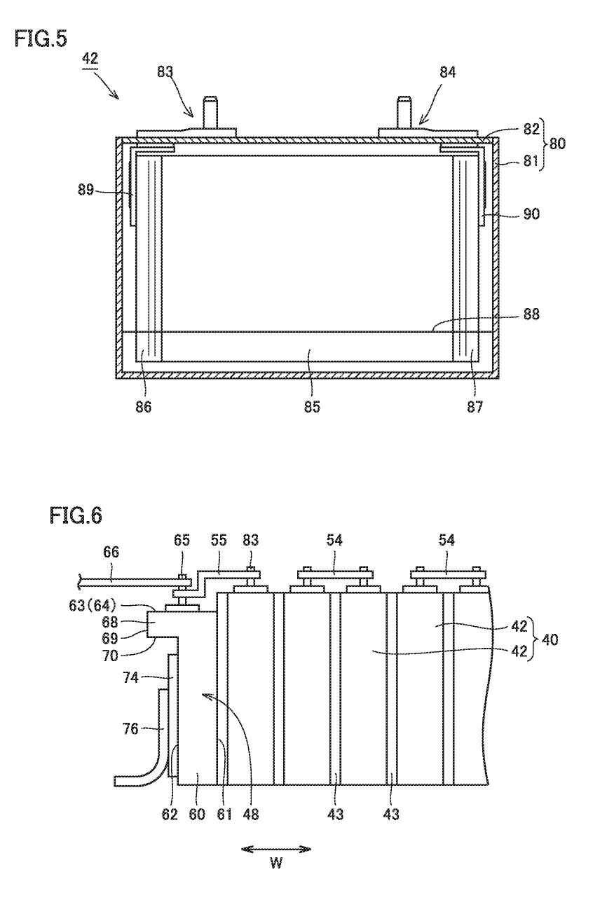

FIG. 6 is a schematic view of stack 40 of cells 42 and end plate 48 which are viewed laterally. As shown in FIG. 6, cells 42 are stacked in width direction W with an insulating plate 43 therebetween to constitute stack 40. An inter-cell connection bus bar 54 is connected to two adjacent cells 42. Inter-cell connection bus bar 54 electrically connects positive electrode external terminals 83 of adjacent cells 42 to each other and electrically connects negative electrode external terminals 84 of the adjacent cells 42 to each other. Inter-cell connection bus bar 54 connects cells 42 adjacent to each other in width direction W in series.

End plate 48 has a plate main body 60. Plate main body 60 has an approximately rectangular plate shape. Plate main body 60 has an inner surface 61 facing stack 40, an outer surface 62 opposite to inner surface 61, and an upper surface 63. Inner surface 61 is held in contact with stack 40 of cells 42. Reinforcing bracket 74 is attached to outer surface 62. Reinforcing bracket 74 extends approximately parallel to end plate 48 and is disposed to cover outer surface 62 of plate main body 60, thereby improving the rigidity of end plate 48.

As shown in FIGS. 4 and 6, upper surface 63 of end plate 48 has a recess-shaped portion 64 in which the central portion of upper surface 63 in front-rear direction D is recessed. Recess-shaped portion 64 is provided with a terminal 65. Terminal 65 is provided in recess-shaped portion 64 forming part of upper surface 63 of end plate 48 and projects upward from upper surface 63 of end plate 48. Terminal 65 is formed of, for example, a bolt fixed to upper surface 63 of end plate 48 by thermocompression.

Positive electrode external terminal 83 of cell 42 of cells 42 stacked, which is disposed closest to end plate 48, and terminal 65 provided in end plate 48 are electrically connected to each other by a cell-end-plate connecting bus bar 55. Cell-end-plate connecting bus bar 55 has an L-shape in plan view. Inter-cell connection bus bars 54 and cell-end-plate connecting bus bar 55 may be modularized so as to be handled integrally.

Terminal 65 is connected with cell-end-plate connecting bus bar 55, as well as an inter-module connecting bus bar 66. Inter-module connecting bus bar 66 electrically connects battery module 30 to battery module 35 (see FIG. 3). Battery module 30 and battery module 35 are connected in series via terminal 65 and inter-module connecting bus bar 66. Terminal 65 forms part of the configuration for electrically connecting battery module 30 and battery module 35 adjacent to each other.

End plate 48 has a projection 68 whose upper portion projects in width direction W. Projection 68 projects from plate main body 60 to be away from stack 40 in width direction W. Projection 68 projects with respect to outer surface 62 of plate main body 60. Projection 68 is formed of recess-shaped portion 64, which projects in width direction W, of upper surface 63 of end plate 48.

Projection 68 projects from outer surface 62 by an amount greater than that of reinforcing bracket 74 attached to outer surface 62. The height by which projection 68 projects from outer surface 62 is greater than a maximum dimension in width direction W of reinforcing bracket 74. The height by which projection 68 projects from outer surface 62 is greater than a value of the total thickness of reinforcing bracket 74 and the first surface of attachment bracket 76 stacked in width direction W.

Part of terminal 65 is provided in projection 68. Of upper surface 63 of end plate 48, recess-shaped portion 64 provided with terminal 65 projects in width direction W, thereby forming projection 68. As shown in FIG. 6, part of terminal 65 is positioned to be away from stack 40 with respect to outer surface 62 of plate main body 60. Part of terminal 65 projects with respect to outer surface 62. The range in which projection 68 is provided in width direction W and the range in which terminal 65 is provided in width direction W overlap each other.

Projection 68 has a flat tip end surface 69. Tip end surface 69 runs in the up-down direction. Projection 68 has a flat lower surface 70 facing downward. Tip end surface 69 and lower surface 70 shown in FIG. 6 run orthogonal to each other. Tip end surface 69 has a lower edge defining a boundary between lower surface 70 and tip end surface 69, and at the lower edge, tip end surface 69 and lower surface 70 form an angle of 90° or less. A flat surface on which tip end surface 69 extends and a flat surface on which lower surface 70 extends intersect each other at a right angle or an acute angle.

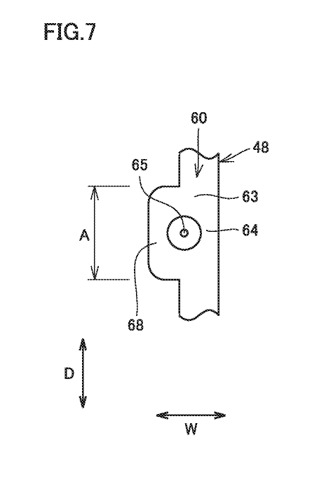

FIG. 7 is a schematic view of end plate 48 and terminal 65 which are viewed in plan view. FIG. 7 is a schematic view of end plate 48 and terminal 65 provided on upper surface 63 (recess-shaped portion 64) of end plate 48, which are viewed from above. In FIG. 7, width direction W which is the stack direction of cells 42 and front-rear direction D which is the direction orthogonal to width direction W are indicated by arrows.

As shown in FIG. 7, in plan view of end plate 48 and terminal 65, terminal 65 is disposed in a range A in which projection 68 is provided in front-rear direction D.

In battery module 30 including the configuration described above, terminal 65 for electrically connecting battery module 30 and battery module 35 adjacent to each other is provided in end plate 48, as shown in FIGS. 4 and 6.

Since terminal 65 is provided in end plate 48, not in cell 42, also when the distance between adjacent battery modules varies due to vibrations of vehicle 1 and stress is accordingly applied to terminal 65, the effect of the stress on cell 42 is reduced, thereby suppressing degradation of cell 42.

As shown in FIGS. 4 and 6, end plate 48 has plate main body 60 and projection 68. Projection 68 is formed such that upper surface 63 of end plate 48 projects from plate main body 60 to be away from stack 40 in width direction W which is the stack direction of cells 42. As shown in FIG. 7, in plan view of battery module 30, terminal 65 is disposed in range A in which projection 68 is provided in front-rear direction D orthogonal to width direction W.

When water seeps into battery case 10 that accommodates battery module 30 and the water accumulates in the vicinity of terminal 65 of upper surface 63 of end plate 48, a path for water flowing down from upper surface 63 along projection 68 is formed. The water flowing from upper surface 63 is suppressed from flowing along outer surface 62, thus suppressing an electrical connection between terminal 65 and reinforcing bracket 74 through the flowing water. A short circuit between terminal 65 and reinforcing bracket 74 can thus be suppressed.

As shown in FIGS. 6 and 7, part of terminal 65 is provided in projection 68. Defining the disposition of terminal 65 in this manner allows water flowing through the vicinity of terminal 65 to more reliably flow down along projection 68, more reliably suppressing a short circuit between terminal 65 and reinforcing bracket 74 through the water flowing along outer surface 62.

Also, as shown in FIG. 6, projection 68 projects with respect to outer surface 62. Reinforcing bracket 74 is attached to outer surface 62. Projection 68 projects from outer surface 62 by an amount greater than that of reinforcing bracket 74. A configuration in which projection 68 projects from outer surface 62 by an amount greater than that of reinforcing bracket 74 avoids water flowing down from projection 68 to reinforcing bracket 74. Since flow of the water flowing down from upper surface 63 through reinforcing bracket 74 is avoided, an electrical connection between terminal 65 and reinforcing bracket 74 through the flowing water can be suppressed more reliably.

As shown in FIGS. 4 and 6, recess-shaped portion 64 formed of a recessed part of upper surface 63 of end plate 48 is formed, terminal 65 is formed in recess-shaped portion 64, and projection 68 is formed of recess-shaped portion 64 projecting in width direction W. Although the water that has arrived at upper surface 63 of end plate 48 is easily guided by a recessed shape of upper surface 63 to accumulate in the vicinity of terminal 65, owing to projection 68 formed of projecting recess-shaped portion 64, the water that has accumulated in the vicinity ofterminal 65 flows down along projection 68 without flowing along outer surface 62. This can more reliably suppress an electrical connection between terminal 65 and reinforcing bracket 74 through the flowing water.

Also, as shown in FIG. 6, tip end surface 69 of projection 68 runs in the up-down direction. This allows the water flowing down from upper surface 63 of end plate 48 along projection 68 to easily flow along tip end surface 69 to drip from the lower edge of tip end surface 69. Water flowing down from projection 68 to reinforcing bracket 74 can thus be avoided more reliably, more reliably suppressing an electrical connection between terminal 65 and reinforcing bracket 74 through the flowing water.

Also, as shown in FIG. 6, tip end surface 69 and lower surface 70 of projection 68 form an angle of 90° or less at the lower edge of tip end surface 69. This can suppress water from flowing from the lower edge of tip end surface 69 along lower surface 70 toward outer surface 62, more reliably causing water to drip from the lower edge of tip end surface 69. This can more reliably avoid water flowing from projection 68 to reinforcing bracket 74.

### Embodiment 2

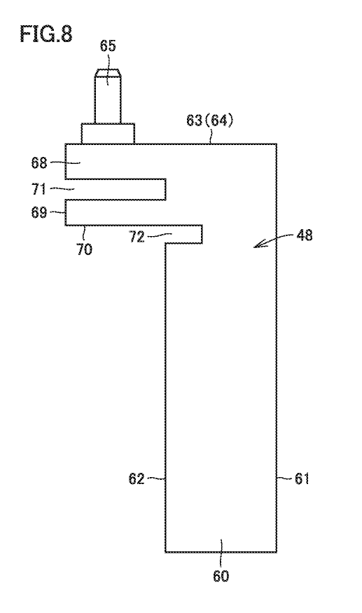

FIG. 8 is a side view showing a configuration of end plate 48 according to Embodiment 2. As shown in FIG. 8, in end plate 48 of Embodiment 2, terminal 65 is entirely provided in projection 68. Positioning the entire terminal 65 to project with respect to outer surface 62 suppresses water flowing down from the vicinity of terminal 65 from passing through outer surface 62. This more reliably suppresses an electrical connection between terminal 65 and reinforcing bracket 74 through the flowing water.

In end plate 48 of Embodiment 2, a groove 71 is further formed in tip end surface 69 of projection 68, and a groove 72 is formed in a portion which connects lower surface 70 of projection 68 to outer surface 62. Grooves 71 and 72 extend in the direction crossing the up-down direction (the up-down direction in FIG. 8), typically the direction orthogonal thereto. Grooves 71 and 72 extend in the left-right direction in FIG. 8 and also in the direction perpendicular to the sheet of FIG. 8. Also with reference to FIG. 4, grooves 71 and 72 extend in front-rear direction D and width direction W of vehicle 1.

Forming grooves 71 and 72 in this manner forms an irregular shape having the drainage function in tip end surface 69 of projection 68. This irregular shape can more effectively suppress water flowing down along tip end surface 69 from flowing through outer surface 62. Consequently, an electrical connection between terminal 65 and reinforcing bracket 74 through the flowing water can be suppressed more reliably.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A battery module mounted in a vehicle, the battery module comprising:
a stack including a plurality of cells stacked,
an end plate disposed on at least one side of the stack in a stack direction of the plurality of cells; and
a terminal provided on an upper surface of the end plate for electrically connecting a plurality of the battery modules adjacent to each other,
the end plate having
a main body having a plate shape, and
a projection formed of the upper surface projecting from the main body to be away from the stack in the stack direction,
in plan view of the battery module, the terminal being disposed in a range in which the projection is provided in an orthogonal direction orthogonal to the stack direction.

2. The battery module according to claim 1, wherein at least part of the terminal is provided in the projection.

3. The battery module according to claim 1, wherein
the main body has an inner surface facing the stack and an outer surface opposite to the inner surface, and the projection projects with respect to the outer surface,
the battery module further comprises a conductor attached to the outer surface, and
the projection projects from the outer surface by an amount greater than that of the conductor.

4. The battery module according to claim 1, wherein
the end plate has a recess-shaped portion formed of a recessed part of the upper surface,
the terminal is provided in the recess-shaped portion, and
the projection is formed of the recess-shaped portion projecting in the stack direction.

5. The battery module according to claim 1, wherein the projection has a tip end surface running in an up-down direction.

6. The battery module according to claim 5, wherein
the projection has a lower surface facing downward, and
at a lower edge of the tip end surface which defines a boundary between the lower surface and the tip end surface, the tip end surface and the lower surface form an angle of 90° or less.

7. The battery module according to claim 5, wherein the tip end surface has a groove running in a direction crossing the up-down direction.
